(19) United States
(12) Patent Application Publication
(10) Pub. No.: US 2015/0292799 A1
(43) Pub. Date: Oct. 15, 2015

(54) PART DRYING DEVICE AND PART WASHING DEVICE USING SUCH DRYING DEVICE

(71) Applicant: Claire MAUREL, Saint Saire (FR)

(72) Inventor: Claire MAUREL, Saint Saire (FR)

(21) Appl. No.: 14/683,676

(22) Filed: Apr. 10, 2015

(30) Foreign Application Priority Data
Apr. 14, 2014 (FR) 1453303

(51) Int. Cl. F26B 3/04; F26B 25/16; B08B 3/02; F26B 11/18

(52) U.S. Cl. CPC F26B 3/04; F26B 11/18; F26B 25/16; B08B 3/02

(57) ABSTRACT

A part drying device, includes a processing chamber having a side wall closed at both ends by a bottom and an upper wall to form an enclosure, the interior of the enclosure being accessible by an opening which can be sealingly closed, a liquid outlet connected to the processing chamber to collect the liquid supplied during the drying of the part, a power supply, an air supply supplying unit for blowing air in the processing chamber to blow air on the part arranged in the processing chamber, wherein the part drying device further includes elements for blowing air on the inner walls of the processing chamber.

### CROSS REFERENCE TO RELATED APPLICATIONS

Applicant claims priority under 35 U.S.C. 119 of French patent application No. 1453303 filed on Apr. 14, 2014.

### BACKGROUND OF THE INVENTION

The present invention relates to the technical field of part or component washing, and particularly to a part drying device, said drying device simultaneously drying the part and the inner walls of the chamber of the device in which the part is dried.

Part cleaning is an essential step for the development of products in many industries such as automotive industry, fine mechanics, electronics, watchmaking, informatics, aeronautics, medical devices, etc. Part cleaning is particularly necessary after machining operations, before performing operations of mounting surface processing or part assembly.

Thus, for example, after machining operations, cleaning steps with detergent-type solutions or other solutions are necessary to degrease mechanical parts and, once these cleaning steps are completed, the mechanical parts must be dried during a drying step. This drying step must be as efficient and quick as possible to minimize the manufacturing time of products.

A first solution contemplated to perform this drying step is to allow the part to drip on a support once the washing step is completed. However, this solution requires time, causes degradation problems for some parts and its efficiency is not optimal.

Another solution contemplated to perform this drying step is to use nozzles to spray air on the part to be treated, as described in the US patent application US2012080063. This patent application describes a washing apparatus comprising a capsule-shaped washing chamber, the upper part of the capsule comprising first nozzles to spray a washing fluid on the part to be treated and second nozzles to spray, after the washing step, air on the part to be treated so as to dry it.

However, this washing and drying apparatus does not allow to obtain an optimal drying time and does not allow to dry the part to be treated in a targeted manner, the nozzles allowing to dry the part being arranged only on the upper part of the capsule and being oriented only toward the part to be treated.

Another device for drying a part after a washing process is a device for processing machining parts such as described in the European patent application EP2156905. This patent application describes a device comprising a processing chamber in which a part is washed and dried via a nozzle device rotating around the part to be treated and spraying a cleaning liquid (washing step) then air (drying step) on the part to be treated, the nozzles of the nozzle device being oriented toward the part to be treated.

However, this washing and drying device does not allow to dry the part in an optimal time, and as the nozzles are oriented only toward the part to be treated, the parts can be wetted again by water held in the chamber during successive manipulations.

### BRIEF SUMMARY OF THE INVENTION

The present invention is intended to solve the disadvantages of the prior art and relates to a part drying device simultaneously drying, in a processing chamber, the part to be treated and the inner walls of the processing chamber, which allows to reduce the drying time of the part, in particular after a washing process. Said part drying device can be integrated in a washing and drying machine or constitute an autonomous drying device.

The present invention allows to perform a more efficient and targeted drying operation on the part to be treated and to reduce the duration of this operation by drying the part via nozzles blowing air, and simultaneously drying the inner walls of the processing chamber of the device via ports blowing air, the inner walls of the processing chamber optionally comprising liquid traps guiding the trapped liquid to a liquid outlet of the device.

The present invention also relates to a washing machine comprising such part drying device which is more efficient, further reducing the total time of the washing and drying processes of the washing machine.

The present invention also relates to a part drying method using such part drying device.

Thus, the invention relates to a part drying device, comprising a processing chamber having a side wall closed at both ends thereof by a bottom and an upper wall to form an enclosure, the interior of which is accessible by an opening which can be sealingly closed, a liquid outlet connected to the processing chamber to collect the liquid generated during the drying of the part, a power supply, an air supply supplying air to means for blowing air in the processing chamber to blow air on the part arranged in the processing chamber, wherein the part drying device further comprises means for blowing air on the inner walls of the processing chamber.

Thus, a reduction of the drying time and an increase of drying efficiency are obtained, the inner walls of the processing chamber of the part drying device and the part to be treated being simultaneously dried, which reduces the saturation vapor pressure in the processing chamber.

According to a particular feature of the invention, the means for blowing air on the part is a part drying ramp provided with nozzles, connected to the air supply by a rotating joint, said part drying ramp being driven in rotation around the part such that the nozzles remain oriented toward the part when the part drying ramp is rotated around the part.

Thus, a targeted air blow on the part to be treated is performed, thereby increasing the drying efficiency.

According to a particular feature of the invention, the means for blowing air on the inner walls of the processing chamber is a wall drying ramp, said wall drying ramp being connected to the air supply by a rotating joint and comprising a longitudinal portion having the same direction as the height of the side wall, the wall drying ramp being rotated in loops in front of the inner side wall of the processing chamber, the length of the longitudinal portion of the wall drying ramp being preferably equal or close to the height of the side wall, the air from the air supply being blown by one or more ports arranged on the wall drying ramp and maintained oriented toward the inner side wall of the processing chamber when the wall drying ramp is rotated in loops inside the processing chamber.

The wall drying ramp can extend at both ends of its longitudinal portion by two ramps perpendicular to its longitudinal portion, so as to dry the bottom and the upper wall of the processing chamber, without departing from the scope of the present invention. Advantageously, an orientation of the nozzles toward the bottom of the processing chamber can create a down-spiral phenomenon during the rotation of the ramp, facilitating the liquid discharge.

Thus, a targeted air blowing operation on the inner side wall of the processing chamber is performed, allowing to reduce the effective drying time of the part.

According to a particular feature of the invention, the means for blowing air on the part and the means for blowing air on the inner walls of the processing chamber both are on a common ramp connected to the air supply by a rotating joint and comprising a longitudinal portion having the same direction as the height of the side wall, said common ramp being driven in rotation around the part, the length of the common ramp being preferably equal or close to the height of the side wall of the processing chamber, air from the air supply being blown on the part by nozzles arranged on the side of the common ramp facing the part, and air from the air supply being blown on the inner walls of the processing chamber by one or more ports provided on the side of the common ramp, said ports facing the inner side wall of the processing chamber when the common ramp is rotated around the part.

Thus, the volume of the means for blowing air is reduced, which allows to increase the compactness of the part drying device. In addition, both means for blowing air being arranged on a common ramp, only one means for rotating around the part must be provided and power supplied.

However, without departing from the scope of the present invention, the part drying ramp and the wall drying ramp can be independent, namely the part drying ramp can be still and the wall drying ramp can be rotated in loops in front of the inner side wall of the processing chamber. Both ramps can be supplied by a single air supply or two different air supplies, a compressed air supply for the part drying ramp, and a normal air supply (for example, a fan) for the wall drying ramp.

According to a particular feature of the invention, the part drying ramp and/or wall drying ramp of the means for blowing air on the part and the inner walls of the processing chamber is a ring-shaped ramp moving around the part according to a vertical or lateral back-and-forth movement.

A mechanical device providing the ramp with a vertical oscillating movement can allow the ramp to cover the entire surface to be dried, thereby improving the drying efficiency and speed, by improving the discharge and circulation of water droplets.

According to a particular feature of the invention, the wall drying ramp or the common ramp of the means for blowing air on the inner walls of the processing chamber comprises only one port in the form of a slot extending along the length of the ramp and maintained oriented toward the inner side wall of the processing chamber when the wall drying ramp or the common ramp is rotated inside the processing chamber so as to dry the wall and/or the wall and the part.

According to a particular feature of the invention, the nozzles of the part drying ramp or the common ramp of the means for blowing air on the part are aligned along a longitudinal direction of the ramp.

According to a particular feature of the invention, the air supplied by the air supply is compressed air or air blown by a fan.

Thus, compressed air blown at a high flow rate on the part to be treated and on the inner walls of the processing chamber allows to increase the drying efficiency of the part.

According to a particular feature of the invention, liquid traps are formed on the inner side wall of the processing chamber, the liquid traps being in the form of a slot extending along the direction of the height of the processing chamber and opening to the exterior of the processing chamber on a chute guiding the trapped liquid to the liquid outlet.

Thus, the liquid on the inner side wall of the processing chamber is blown in the liquid traps via the means for blowing air on the inner walls of the processing chamber, and is then oriented toward the liquid outlet via the chute. Thus, the liquid stays less time on the inner side wall of the processing chamber, which allows to further reduce the drying time.

According to a particular feature of the invention, the side wall of the processing chamber has a cross-sectional square, rectangular or round shape.

The invention also relates to a washing machine comprising a power supply, a washing solution supply and a part drying device such as described above, wherein the washing machine further comprises means for washing parts arranged inside the processing chamber of the part drying device, the means for washing parts being a ramp connected to the washing solution supply by a rotating joint and driven in rotation around the part, a washing solution from the washing solution supply being sprayed on the part by nozzles provided on the ramp.

Thus, the part drying device can be integrated to a washing machine, which allows to reduce the total time of the washing and drying processes of the washing machine.

According to a particular feature of the invention, the ramp of the means for washing parts is the same as the common ramp of the means for blowing air on the part and the means for blowing air on the inner walls of the processing chamber, the washing solution being sprayed by the same nozzles as the air or by different nozzles.

Thus, the volume of the means for blowing air and the means for washing parts is reduced, which allows to increase the compactness of the washing machine. In addition, both means for blowing air and means for washing parts being arranged on a common ramp, only one means for rotating around the part must be provided and power supplied.

The washing solution of the washing machine can be a detergent solution, oil, soluble oil, water, demineralized water or a solvent, without departing from the scope of the present invention.

The invention also relates to a part drying method, wherein the method comprises drying a part to be dried arranged in a processing chamber forming a closed enclosure, by spraying air on the part and simultaneously spraying air on the inner walls of the processing chamber.

The drying method can be used alone or in combination with a prior washing step or a vacuum drying step.

The technical effect of the drying operation of the walls of the processing chamber along with the drying operation of the part is to significantly reduce the drying time of the part.

When the washing step and the drying method are performed in the same processing chamber, the drying operation of the inner wall of the processing chamber ensures a better cleanliness of the processing chamber for a subsequent washing/drying operation, thus better washing and drying operations for parts.

It is obvious, without departing from the scope of the present invention, that several parts can be dried and/or simultaneously washed and dried in the same processing chamber.

### BRIEF DESCRIPTION OF THE SEVERAL VIEWS OF THE DRAWING

Other advantages and features will become more apparent from the description of a particular embodiment of the invention, in reference with the appended drawings:

FIG. 1 shows a perspective view of a part drying device according to a first embodiment of the present invention;

FIG. 2 shows a cross-sectional view of the part drying device of FIG. 1;

FIG. 3 shows a top view of the part drying device of FIG. 1;

FIG. 4 shows a top view of a part drying device according to a second embodiment of the present invention;

FIG. 5 shows a top view of a part drying device according to a third embodiment of the present invention; and

FIG. 6 shows a block diagram of a washing and drying machine according to the present invention.

### DETAILED DESCRIPTION OF THE INVENTION

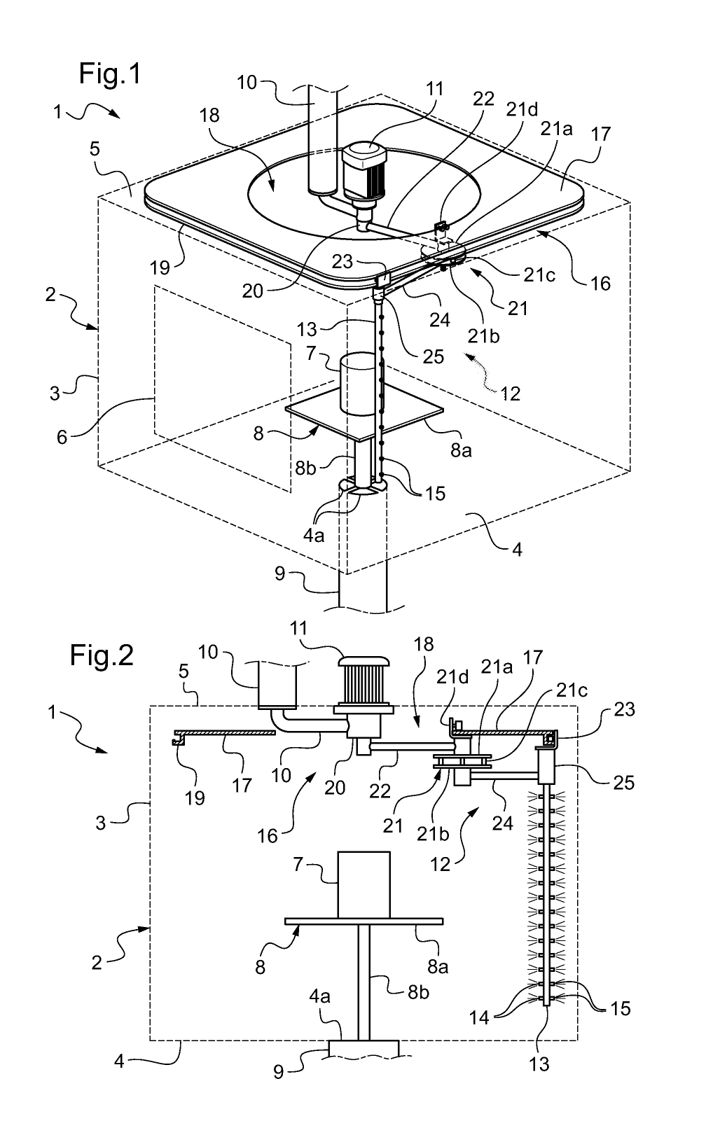

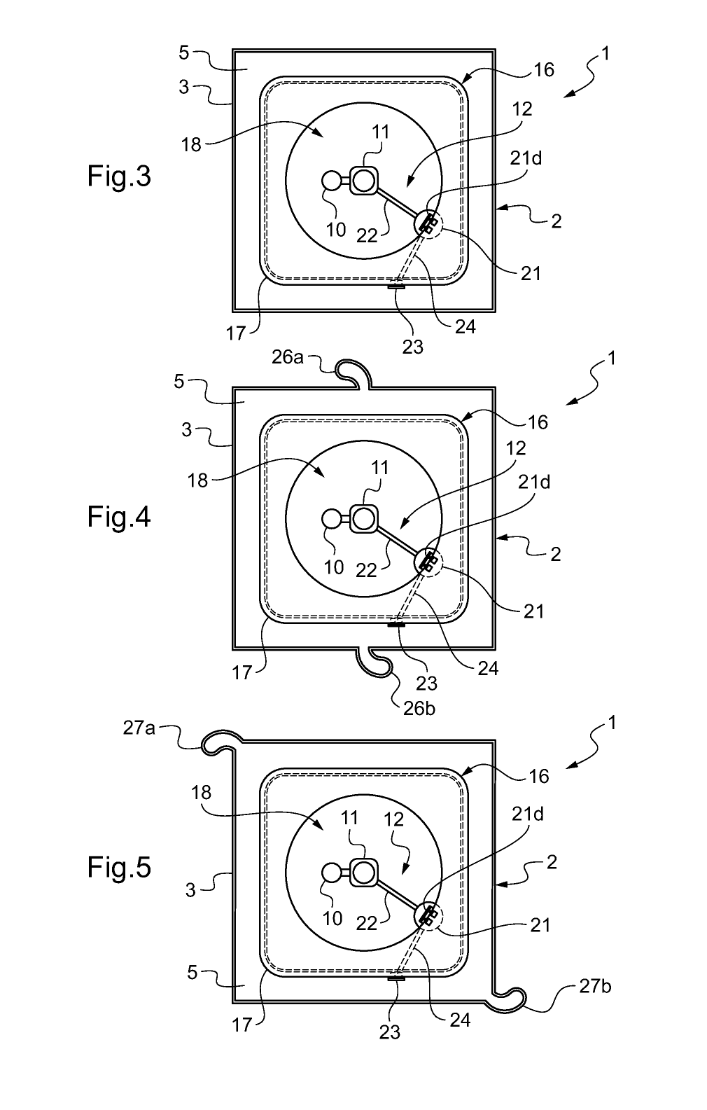

With reference to FIGS. 1, 2 and 3, a part drying device 1 is shown according to a first embodiment of the invention.

The part drying device 1 comprises a processing chamber 2 having a side wall 3 closed at both ends thereof by a bottom 4 and an upper wall 5 to form a closed enclosure.

The walls of the processing chamber 2 are shown in dotted lines to better distinguish the interior of the processing chamber 2.

The side wall 3 of the processing chamber 2 has a cross-sectional square shape in the embodiment shown, even though this representation is not intended to limit the scope of the invention.

It can thus be noted that the side wall 3 of the processing chamber 2 could also have a rectangular or round shape.

The side wall 3 could be made of plastic, glass or metal.

The bottom 4 and the upper wall 5 of the processing chamber 2 could be made of plastic, glass or metal.

The interior of the processing chamber 2 is accessible by a door 6 which is formed on one of the faces of the side wall 3 and able to be sealingly closed, by a seal (not shown) arranged on its periphery. The sealed closure of the door 6, even if preferred, is not required.

A part to be dried 7, shown as a cylinder for illustration purposes only and not intended to limit the scope of the invention, is arranged in the processing chamber 2 on a part support 8, said part support 8 comprising a horizontal plane upper part 8a forming a plate on which is disposed the part to be dried 7, and a vertical cylindrical part 8b forming a post connecting the horizontal plane upper part 8a to the center of the bottom 4 of the processing chamber 2.

A liquid outlet 9 is disposed below the processing chamber 2 to collect the liquid generated during the drying operation of the part 7, the liquid outlet 9 being connected to the center of the bottom 4 of the processing chamber 2 via holes 4a formed in the bottom 4.

It can be noted that the bottom 4 of the processing chamber 2 is, preferably but not necessarily, slightly tilted toward the center of the bottom 4, the center of the bottom 4 being lowered with respect to the edges of the bottom 4 so as to allow the liquid from the drying operation of the part 7 to flow to the center of the bottom 4 and then flow in the liquid outlet 9 via the holes 4a.

The liquid outlet 9 is a hollow cylindrical pipe made of plastic, but can also be made of metal.

The part drying device 1 also comprises an air supply 10 and an electrical engine 11 supplied by a power supply (not shown) which are arranged above the processing chamber 2, and means for blowing air 12 on the part 7 and the inner walls of the processing chamber 2, which is arranged in the processing chamber 2, the air supply 10 supplying the means for blowing air 12 with air, and the electrical engine 11 causing the means for blowing air 12 to rotate around the part 7.

The air supply 10 provides the means for blowing air 12 with compressed air or air blown by a fan (not shown).

The means for blowing air 12 comprises a vertical drying ramp 13 having nozzles 14 oriented toward the part 7 and ports 15 oriented toward the inner side wall 3 of the processing chamber 2, and guiding means 16, the drying ramp being driven in rotation around the part 7 by the guiding means 16 such that the nozzles 14 are maintained oriented toward the part 7 and the ports 15 are maintained oriented toward the inner side wall 3 of the processing chamber 2 when the drying ramp 13 is rotated around the part 7, air from the air supply 10 being blown on the part 7 by the nozzles 14 and on the inner side wall 3 of the processing chamber 2 by the ports 15.

The length of the drying ramp 13 is preferably substantially equal to the height of the side wall 3 so as to increase the drying efficiency of the inner side wall 3 by the ports 15. The closer the height of the drying ramp 13 and the height of the side wall 3 of the processing chamber 2, the more efficient the drying operation will be.

The nozzles 14 of the drying ramp 13 are aligned along a longitudinal direction of the drying ramp 13.

It can be noted that the drying ramp 13 could comprise a single port in the form of a slot extending along the length of the drying ramp 13 so as to dry the inner side wall 3 of the processing chamber 2.

The drying ramp 13 is preferably made of metal, but could also be made of plastic or composite material.

The guiding means 16 of the means for blowing air 12 comprises a guiding plate 17 having a square shape with rounded corners, having a circular opening 18 at the center thereof and a rail 19 arranged at the outer edge thereof, said guiding plate 17 being disposed at the upper wall 5 of the processing chamber 2 (covered thereby), and a rotating joint assembly 20 which is arranged at the center of the opening 18 of the guiding plate 17 and is supplied with air by the air supply 10.

The guiding means 16 further comprises a disc assembly 21 having two discs 21a, 21b with a bearing 21c between both discs 21a, 21b, the disc assembly 21 being slidably attached to the edge of the opening 18 of the guiding plate 17 via a wheel hanger 21d attached to the upper part of the upper disc 21a.

The rotating joint assembly 20 and the disc assembly 21 are connected to each other by a horizontal arm 22, thus the rotation of the rotating joint assembly 20 causes the disc assembly 21 to rotate on the edge of the opening 18 of the guiding plate 17.

The upper end of the drying ramp 13 has a wheel hanger 23 slidably attached to the rail 19 of the guiding plate 17.

The disc assembly 21 and the upper end of the drying ramp 13 are connected to each other by a second horizontal arm 24, the second horizontal arm 24 being attached to the upper end of the drying ramp 13 via a pivot linkage 25, thus the rotation of the disc assembly 21 on the edge of the opening 18 of the guiding plate 17 causes the drying ramp 13 to rotate on the rail 19 of the guiding plate 17.

Thus, the rotation of the rotating joint assembly causes the drying ramp 13 to rotate according to a square pitch around the part 7 while going along the inner side wall 3 of the processing chamber 2, the nozzles 14 of the drying ramp 13 blowing air on the part 7 and the ports 15 of the drying ramp 13 blowing air on the inner side wall 3 of the processing chamber 2. The system of the invention allows to permanently maintain the nozzles 14 toward the part 7 and the ports 15 toward the side wall 3 when the ramp is rotated around the part 7.

The liquid present on the part 7 and the inner side wall 3 is thus blown by the drying ramp 13 and falls by gravity on the bottom 4 of the processing chamber 2 and within the liquid outlet 9 via holes 4a formed in the bottom 4 of the processing chamber 2.

It can be noted that the part drying device 1 could comprise means for blowing air on the part 7 and means for blowing air on the inner side wall 3 of the processing chamber 2, independent from each other, the means for blowing air on the part comprising a ramp provided with nozzles and driven in rotation around the part 7 such that the nozzles are maintained oriented toward the part 7 when the ramp is rotated around the part 7, and the means for blowing air on the inner side wall 3 comprising a ramp, different from the ramp of the means for blowing air on the part 7, provided with ports and rotated in loops in front of the inner side wall 3 of the processing chamber 2, the ports being maintained oriented toward the inner side wall 3 of the processing chamber 2 when the ramp is rotated in loops in the processing chamber 2.

Furthermore, the system for rotating the ramp is not limited to the system described in connection with the figures, any system for rotating the ramp being contemplated in the scope of the present invention, the advantage of the system described consisting in allowing to maintain, during the rotation of the drying ramp, a substantially constant distance between the drying ramp and the side wall of the processing chamber, which ensures an even drying.

With reference to FIG. 4, a part drying device is shown according to a second embodiment of the invention.

According to this second embodiment of the invention, the part drying device 1 comprises two liquid traps 26a, 26b arranged on two opposite faces of the side wall 3 of the processing chamber 2, the liquid traps 26a, 26b being in the form a slot extending along the direction of the height of the processing chamber 2 to the exterior of the processing chamber 2 on a chute guiding the liquid trapped during the drying operation by the means for blowing air 12 to the bottom 4 of the processing chamber 2, the liquid then flowing to the liquid outlet 9 of the part drying device 1.

With reference to FIG. 5, a part drying device 1 is shown according to a third embodiment of the invention.

According to this third embodiment of the invention, the part drying device 1 comprises two liquid traps 27a, 27b arranged at two opposite angles of the side wall 3 of the processing chamber 2, the liquid traps 27a, 27b being in the form of a slot extending along the direction of the height of the processing chamber 2 to the exterior of the processing chamber 2 on a chute guiding the liquid trapped during the drying operation by the means for blowing air 12 to the bottom 4 of the processing chamber 2, the liquid then flowing to the liquid outlet 9 of the part drying device 1.

It can be noted that the part drying device 1 could comprise a single liquid trap or more than two liquid traps arranged on the side wall 3 of the processing chamber or, when required, in at least one of the corners thereof, without departing from the scope of the present invention.

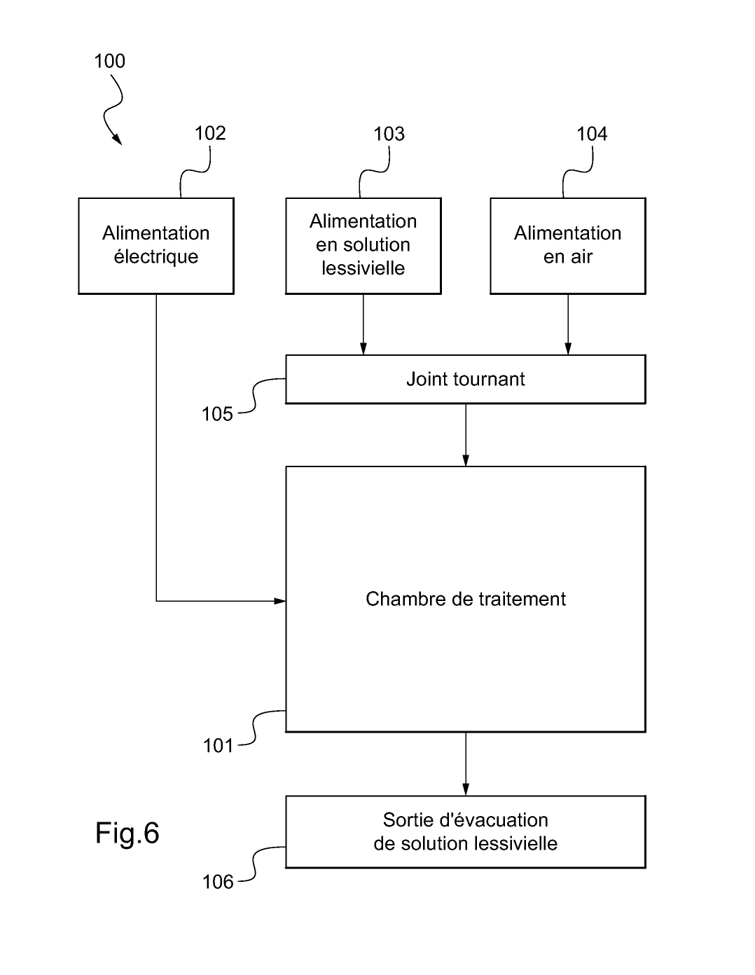

With reference to FIG. 6, a block diagram of the washing machine 100 according to the present invention is shown.

The washing machine 100 comprises a processing chamber 101, a power supply 102, a detergent solution supply 103, an air supply 104, a rotating joint 105 and a detergent solution outlet 106.

Even though in this embodiment, the washing solution of the washing machine 100 is a detergent solution, it can be noted that the washing solution could also be oil, soluble oil, water, demineralized water or a solvent, without departing from the scope of the present invention.

The power supply 102 supplies the processing chamber 101 with electricity, and the detergent solution supply 103 and the air supply 104 respectively supply the rotating joint 105 with detergent solution and air, the rotating joint 105 then supplying the processing chamber 101 with detergent solution or air.

The processing chamber 101 of the washing machine 100 comprises therein means for washing parts and means for blowing air on the part and the inner side wall of the processing chamber 101.

The means for blowing air is the same as the means for blowing air 12 of the part drying device 1 according to the present invention.

The washing means is a ramp driven in rotation around the part, a detergent solution being sprayed on the part by nozzles provided on the ramp.

The rotating joint 105 causes the means for blowing air and the washing means to rotate while supplying the washing means with detergent solution and the means for blowing air with air.

It can be noted that the ramp of the washing means can be the same as the ramp of the means for blowing air on the part and the inner side wall of the processing chamber 101, the detergent solution being sprayed on the part by the same nozzles as the air or different nozzles, without departing from the scope of the present invention.

Thus, a part to be treated is arranged within the processing chamber 101 of the washing machine 100, and then a detergent solution from the detergent solution supply is sprayed on the part by the washing means rotating around the part, and air is then blown by the means for blowing air on the part and the inner side wall of the processing chamber 101, the means for blowing air being rotated around the part, the liquid from the drying operation being drained via the detergent solution outlet 106.

The detergent solution circuit in the ramp can be the same as the circuit blowing air on the part. The circuit blowing air on the walls of the chamber is independent in order not to spray the detergent solution on the walls of the chamber during the washing step. The circuit blowing air on the part and the circuit blowing air on the walls of the chamber can be supplied by the same air supply source, for example compressed air, or the circuit blowing air on the part can be supplied by a compressed air supply and the circuit blowing air on the walls of the chamber can be supplied by a supply of air generated by a fan, for cost reasons.

It can be noted that the part drying device 1 could also be integrated in other installations such as quenching oil machine, machine-tool or rinsing machine.

The part drying device 1 according to the present invention can be used according to a method for drying a part 7, wherein the method comprises drying the part 7 disposed in a processing chamber 2 forming a closed enclosure, by simultaneously spraying air on the part 7 and spraying air on the inner walls 3 of the processing chamber 2.

1. A part drying device, comprising a processing chamber having a side wall closed at both ends by a bottom and an upper wall to form an enclosure, the interior of the enclosure being accessible by an opening adapted to be sealingly closed, a liquid outlet connected to the processing chamber to collect the liquid generated during the drying of the part, a power supply, an air supply supplying means for blowing air in the processing chamber to blow air on the part arranged in the processing chamber, wherein the part drying device further comprises means for blowing air on the inner walls of the processing chamber, the means for blowing air on the part being a part drying ramp provided with nozzles, connected to the air supply by a rotating joint, said part drying ramp being driven in rotation around the part such that the nozzles remain oriented toward the part when the part drying ramp rotates around the part.

2. The part drying device according to claim 1, wherein the means for blowing air on the inner walls of the processing chamber is a wall drying ramp, the wall drying ramp being connected to the air supply by a rotating joint and comprising a longitudinal portion having the same direction as the height of the side wall, the wall drying ramp being rotated in loops in front of the inner side wall of the processing chamber, the air from the air supply being blown by at least one port arranged on the wall drying ramp and maintained oriented toward the inner side wall of the processing chamber when the wall drying ramp is rotated in loops in the processing chamber.

3. The part drying device according to claim 1, wherein the means for blowing air on the part and the means for blowing air on the inner walls of the processing chamber both are on a common ramp connected to the air supply by a rotating joint and comprising a longitudinal portion having the same direction as the height of the side wall, the common ramp being driven in rotation around the part, air from the air supply being blown on the part by nozzles provided on the side of the common ramp facing the part, and air from the air supply being blown on the inner walls of the processing chamber by at least one port provided on the side of the common ramp facing the inner side wall of the processing chamber when the common ramp is rotated around the part.

4. The part drying device according to claim 2, wherein the wall drying ramp of the means for blowing air on the inner walls of the processing chamber comprises one port in the form of a slot extending along the length of the ramp and maintained oriented toward the inner side wall of the processing chamber when the wall drying ramp is rotated in the processing chamber.

5. The part drying device according to claim 3, wherein the common ramp of the means for blowing air on the inner walls of the processing chamber comprises one port in the form of a slot extending along the length of the ramp and maintained oriented toward the inner side wall of the processing chamber when the common ramp is rotated in the processing chamber.

6. The part drying device according to claim 2, wherein the nozzles of the means for blowing air on the part are aligned along a longitudinal direction of the ramp.

7. The part drying device according to claim 3, wherein the nozzles of the means for blowing air on the part are aligned along a longitudinal direction of the ramp.

8. The part drying device according to claim 1, wherein the air supply supplies compressed air.

9. The part drying device according to claim 1, wherein the air supply supplies air blown by a fan.

10. The part drying device according to claim 1, wherein liquid traps are formed on the inner side wall of the processing chamber, the liquid traps being in the form of a slot extending along the direction of the height of the processing chamber and opening to the exterior of the processing chamber on a chute guiding the trapped liquid to the liquid outlet.

11. The part drying device according to claim 1, wherein the side wall of the processing chamber has a cross-sectional square, rectangular or round shape.

12. A washing machine comprising a power supply, a washing solution supply and a part drying device according to claim 1, wherein the washing machine further comprises means for washing parts arranged in the processing chamber of the part drying device, the means for washing parts being a ramp connected to the washing solution supply by a rotating joint and driven in rotation around the part, a washing solution from the washing solution supply being sprayed on the part by nozzles provided on the ramp.

13. A washing machine comprising a power supply, a washing solution supply and a part drying device according to claim 3, wherein the washing machine further comprises means for washing parts arranged in the processing chamber of the part drying device, the means for washing parts being a ramp connected to the washing solution supply by a rotating joint and driven in rotation around the part, a washing solution from the washing solution supply being sprayed on the part by nozzles provided on the ramp.

14. The washing machine according to claim 13, wherein the ramp of the means for washing parts is the same as the common ramp of the means for blowing air on the part and the means for blowing air on the inner walls of the processing chamber, the washing solution being sprayed by the same nozzles as the air or by different nozzles.

15. A part drying method, wherein the method comprises drying a part arranged in a processing chamber forming a closed enclosure of a processing device according to claim 1, by spraying air on the part and simultaneously spraying air on the inner walls of the processing chamber.
